(19) United States
(12) Patent Application Publication
(10) Pub. No.: US 2010/0212982 A1
(43) Pub. Date: Aug. 26, 2010

(54) CUSHIONED PALLET ASSEMBLY

(76) Inventor: Daniel Lin, Taichung City (TW)

Correspondence Address: FROMMER LAWRENCE & HAUG, 745 FIFTH AVENUE- 10TH FL., NEW YORK, NY, 10151, US

(21) Appl. No.: 12/474,634

(22) Filed: May 29, 2009

(30) Foreign Application Priority Data
Feb. 23, 2009 (TW) 098105640

(51) Int. Cl. B60V 1/00; B65D 19/02; B65D 19/38

(52) U.S. Cl. 180/124

(57) ABSTRACT

A cushioned pallet assembly includes a rigid pallet body having four lateral sides, an air bag unit including at least one inflatable air bag mounted to the pallet body and capable of producing a pressurized layer of air beneath the air bag, and an air supply conduit unit connected to the air bag for supplying air to the same. The pallet body further has top and bottom faces. The air bag is disposed below the bottom face of the pallet body.

### CROSS-REFERENCE TO RELATED APPLICATION

This application claims priority of Taiwanese Application No. 098105640, filed on Feb. 23, 2009.

### BACKGROUND OF THE INVENTION

1. Field of the Invention

This invention relates to a pallet, more particularly to a cushioned pallet assembly.

2. Description of the Related Art

Conventionally, a hydraulic hand jack or a forklift may be used to move a pallet from one place to another. Because there is high friction between the loaded pallet and the ground, it is not possible for a worker to push and move the pallet on the ground, so that use of a hydraulic hand jack or forklift is necessary to raise the pallet from the ground and then move the same to a desired place or position.

Although the aforesaid two types of transport machines can be used to move a pallet, use of these transport machines makes it necessary to assess accurately the number of transport machines and the number of skilled workers required prior to a transport operation. Even if the assessment is deemed accurate, situations may nevertheless arise wherein a transport job is waiting to be performed or a worker is waiting for a job to be performed. Further, in using the aforesaid two types of transport machines for transporting the pallet, it is necessary to provide an additional space for movement of these machines within a working site.

### SUMMARY OF THE INVENTION

Therefore, the object of the present invention is to provide a cushioned pallet assembly that can be easily transported.

According to this invention, a cushioned pallet assembly comprises a rigid pallet body having four lateral sides, an air bag unit including at least one inflatable air bag mounted to the pallet body and capable of producing a pressurized layer of air beneath the air bag, and an air supply conduit unit connected to the air bag for supplying air to the same.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a partly exploded perspective view of a cushioned pallet assembly according to the first preferred embodiment of this invention;

FIG. 2 is a perspective view of the first preferred embodiment in an assembled state;

FIG. 3 is a schematic bottom view of the first preferred embodiment;

FIG. 4 is a view similar to FIG. 1, but illustrating main conduits and sub-conduits of an air supply conduit unit disposed within a pallet body;

FIG. 5 is a fragmentary schematic side view of the first preferred embodiment, illustrating an air bag in a non-inflated state;

FIG. 6 is a view similar to FIG. 5, but illustrating the air bag in an inflated state;

FIG. 7 is a view similar to FIG. 5, but illustrating an alternative form of fixing an air bag to a pallet body;

FIG. 8 is a schematic bottom view of an alternative form of an air bag unit of the first preferred embodiment;

FIG. 9 is a partly exploded perspective view of a cushioned pallet assembly according to the second preferred embodiment of this invention; and

FIG. 10 is a perspective view of the second preferred embodiment in an assembled state.

### DETAILED DESCRIPTION OF THE PREFERRED EMBODIMENTS

Before the present invention is described in greater detail, it should be noted that the same reference numerals have been used to denote like elements throughout the specification.

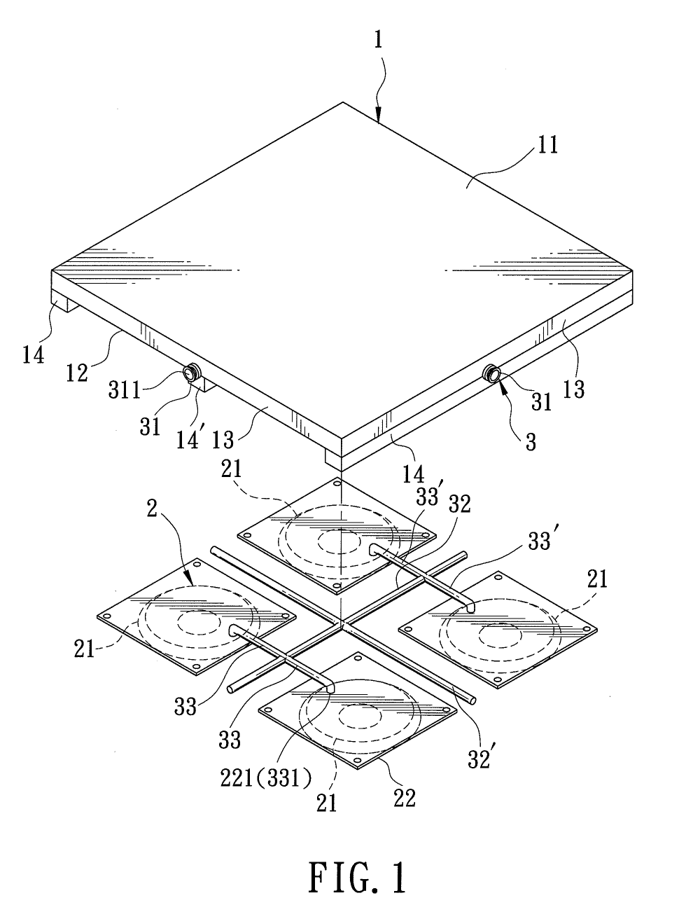

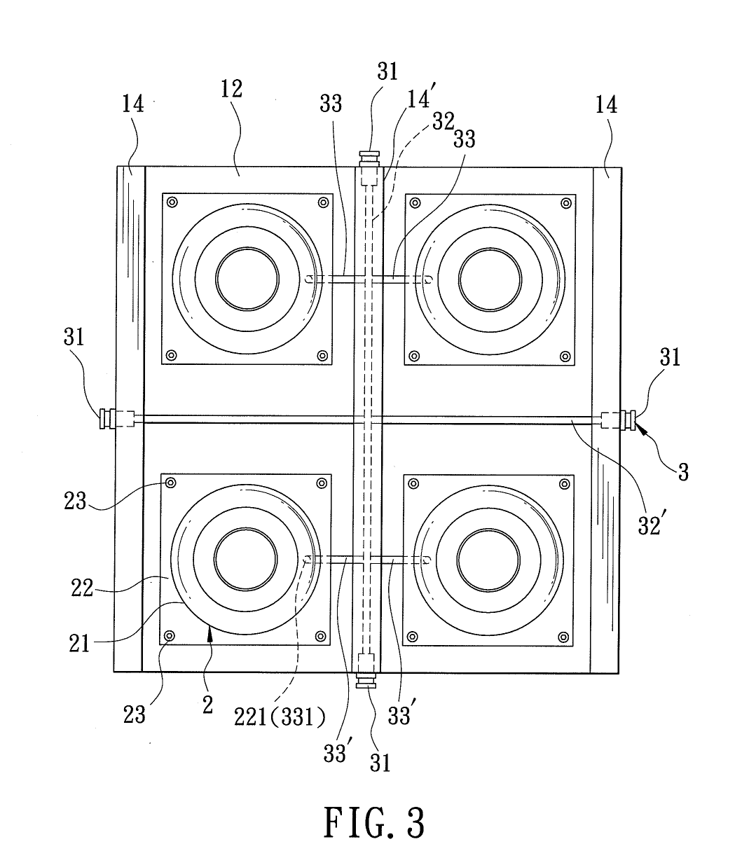

Referring to FIGS. 1 to 5, a cushioned pallet assembly according to the first preferred embodiment of the present invention is shown to comprise a rigid pallet body 1, an air bag unit 2, and an air supply conduit unit 3.

The rigid pallet body 1 has a top face 11 adapted to hold a load, a bottom face 12, four lateral sides 13 interconnecting lateral ends of the top and bottom faces 11, 12, and three parallel and spaced-apart standoff bars 14, 14′ disposed beneath the bottom face 12. Two of the standoff bars 14 extend along two of the lateral sides 13. The standoff bar 14′ is disposed between the standoff bars 14. In this embodiment, the pallet body 1 has a size conforming to international standards, and is thus suitable for use in Taiwan and other countries.

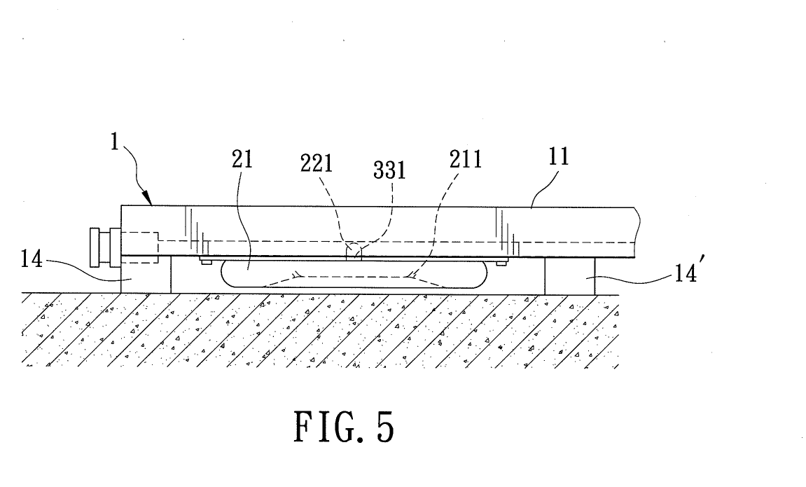

The air bag unit 2 includes four inflatable air bags 21 arranged in intersecting rows and disposed below the bottom face 12 of the pallet body 1, four partition plates 22 fixed respectively to the air bags 21 and connected detachably to the bottom face 12 of the pallet body 1, and a plurality of fasteners 23 to fasten the partition plates 22 to the pallet body 1. Each partition plate 22 has a bag inlet 221 communicating fluidly with the respective air bag 21. Each fastener 23 is configured as a bolt. As best shown in FIG. 5, each air bag 21 has a height smaller than that of each standoff bar 14, 14′, i.e., the air bag 21 is not in contact with the ground when disposed in a non-inflated state, so that a plurality of the pallet bodies 1 may be stacked for storage. A bottom end of each air bag 21 has an annular air jet hole 211.

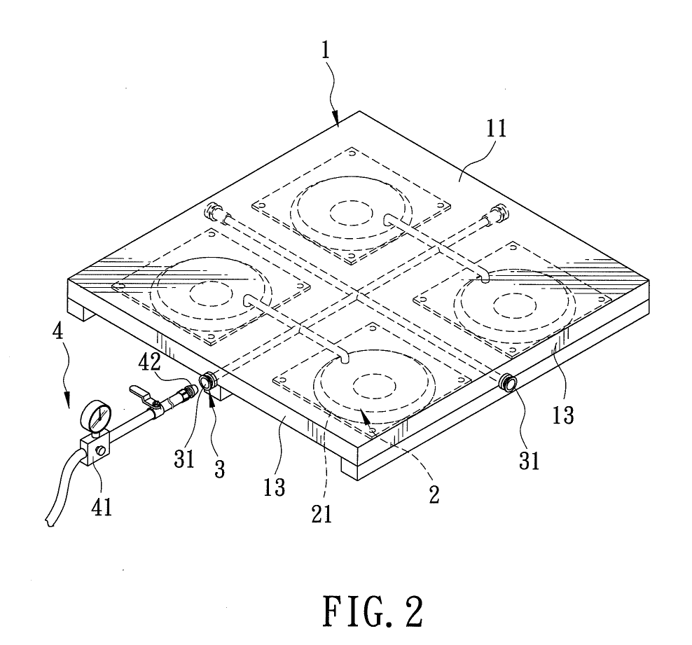

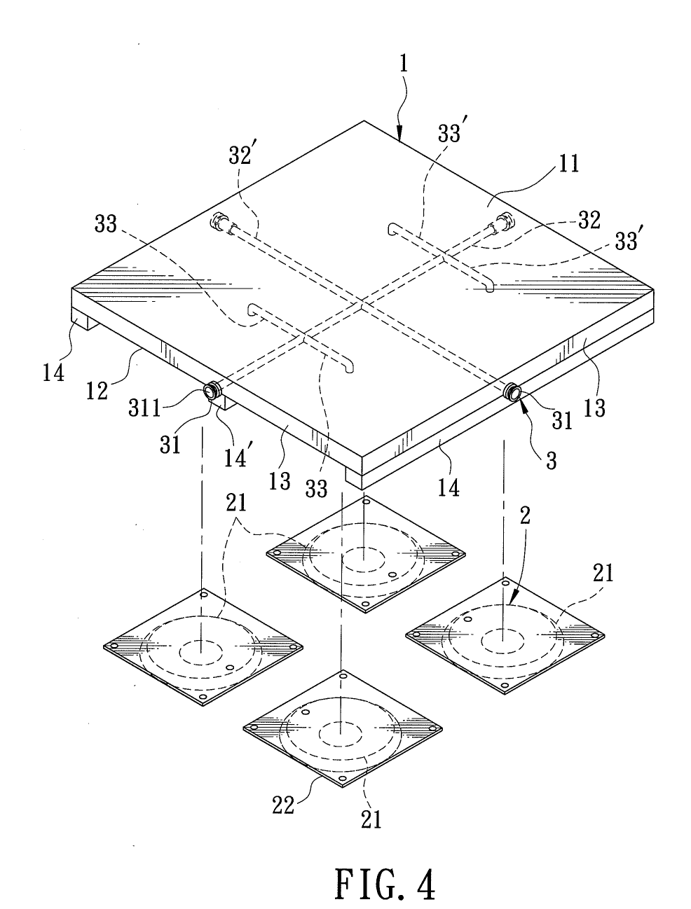

The air supply conduit unit 3 includes four air connectors 31, two intersecting main conduits 32, 32′, and four sub-conduits 33, 33′. The air connectors 31 are disposed respectively on the four lateral sides 13 of the pallet body 1, and respectively have a connector inlet 311 adapted to be connected to an air source 4 (see FIG. 2). Each air connector 31 shuts off after being disconnected from the air source 4. In this embodiment, each air connector 31 is a quick connector. Each main conduit 32, 32′ extends between rows of the air bags 21, and has two opposite ends connected to two of the air connectors 31. Each sub-conduit 33, 33′ extends from the main conduit 32 to one of the air bags 21, and has a conduit outlet 331 connected fluidly to the bag inlet 221 of the respective partition plate 22. The sub-conduits 33 branch oppositely from the main conduit 32 between two of the air bags 21. The sub-conduits 33′ branch oppositely from the main conduit 32 between the other two of the air bags 21. In this embodiment, the main conduit 32 is embedded in the standoff bar 14′, and the main conduit 32′ and the sub-conduits 33, 33′ extend beneath the bottom face 12 of the pallet body 1, and are positioned thereto by using any conventional fixing means. Alternatively, the main conduits 32, 32′ and the sub-conduits 33, 33′ may be formed within the pallet body 1 during injection molding of the latter, so that the conduits 32, 32′, 33, 33′ are integral with the pallet body 1, as best shown in FIG. 4. In this case, costs can be minimized for mass production of the cushioned pallet assembly of the present invention.

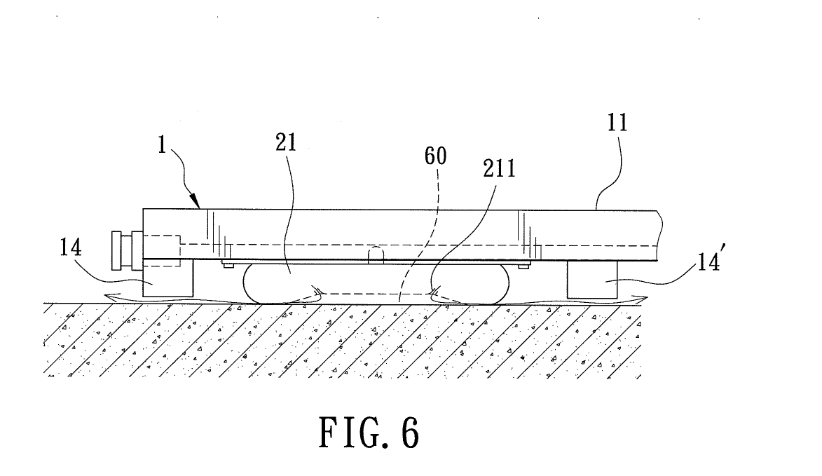

With further reference to FIGS. 5 and 6, when the pallet body 1 with a load (not shown) placed on the top face 11 thereof is to be transferred to another place, a worker first prepares the air source 4 which has a pressure regulating valve 41 and an air outlet connector 42, and connects the air outlet connector 42 to one of the air connectors 31. Pressurized air from the air source 4 is adjusted to a suitable amount of pressure through the pressure regulating valve 41, and is supplied into the air bags 21 after passing through the air outlet connector 42, the connector inlet 311 of the air connector 31, the main conduits 32, 32′, the sub-conduits 33, 33′, and the bag inlets 221, thereby inflating the air bags 21. After each air bag 21 is inflated, a pressurized layer of air 60 is produced beneath the respective air bag 21 via the air jet hole 211, and an upward supporting force can be achieved by the respective air bag 2. When the upward supporting force of each air bag 21 is large enough to raise the respective air bag 2 from the ground, a thin film of air can flow out from beneath the air bag 21, as best shown in FIG. 6. In this state, the standoff bars 14, 14′ rise and leave the ground, and the friction between each air bag 21 and the ground can be reduced to a minimum, which is about 1/1000 of the original force. As a result, the force for pushing and moving the loaded pallet body 1 can be greatly reduced. It is worth mentioning that since the pressurized air entering the air connector 31 directly flows to the conduit outlet 331, an air inlet pressure at the connector inlet 311 of the air connector 31 is similar to an air outlet pressure at one of the conduit outlets 331 of the sub-conduits 33, 33′.

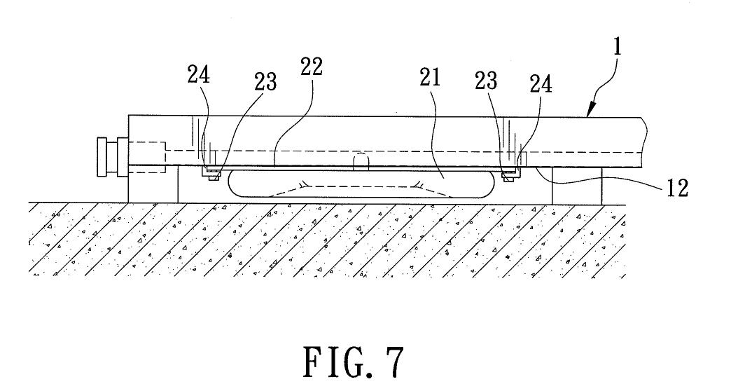

With reference to FIG. 7, the bottom face 12 of the pallet body 1 may be provided with a plurality of pairs of slide rails 24 (only one pair of the slide rails 24 is shown). Each partition plate 22 is slid into one pair of slide rails 24, and is fixed thereto by using the fasteners 23. Each air bag 21 may be similarly fixed to the pallet body 1.

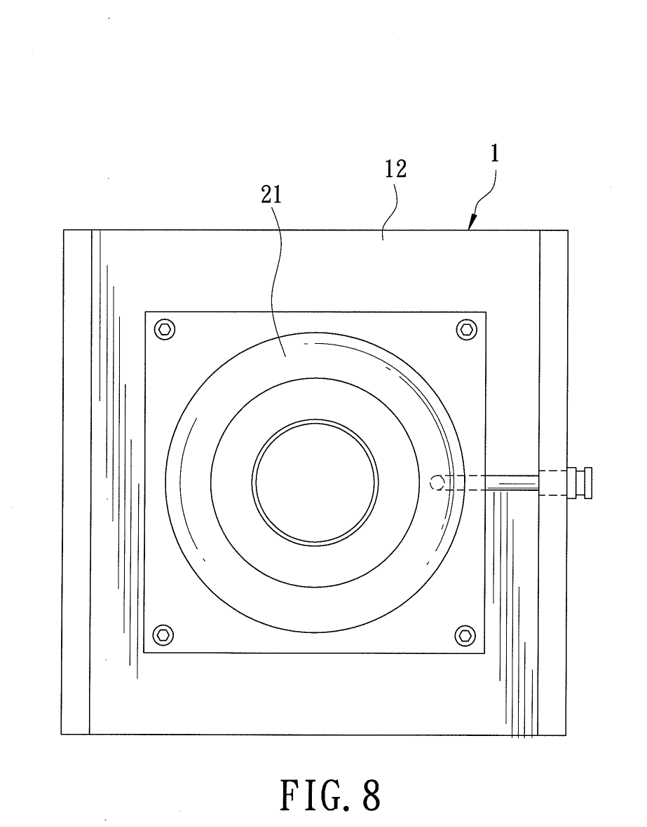

Referring to FIG. 8, it should be noted that when the pallet body 1 is used in circumstances where the load is placed at the center of or is evenly placed on the pallet body 1, only one inflatable air bag 21 may be mounted to the bottom face 12 of the pallet body 1 to accomplish the transporting operation.

From the aforementioned description, the advantages of the present invention can be summarized as follows:

1. When the pressurized air supplied into the air bags 21 through the air connector 31, the main conduits 32, 32′, and the sub-conduits 33, 33′ is adjusted to a suitable amount of pressure by the pressure regulating valve 41, a thin film of air can be formed between each air bag 21 and the ground so as to raise the cushioned pallet assembly and the load on the top face 11 thereof from the ground. Thereafter, taking advantage of the low coefficient of friction between each air bag 21 and the ground, only a light force is necessary to push and move the loaded cushioned pallet assembly to a desired angle and direction.

2. Since the air connectors 31 are disposed respectively on the four lateral sides 13 of the pallet body 1, even if three of the air connectors 31 are covered during storage, there is still one air connector 31 available for connection with the air source 4, so that inflation of the air bags 21 is still possible.

3. The cushioned pallet assembly of the present invention uses the air bags 21 to facilitate movement and positioning, unlike the conventional pallet assembly which requires use of a transport machine. As a result, an additional space for turning or moving the cushioned pallet assembly of the present invention is not necessary since the cushioned pallet assembly can be directly pushed by a worker to any angle and advanced to any direction as desired, without use of a transport machine.

4. Since the cushioned pallet assembly of the present invention uses the air bags 21 for movement and positioning, only air is discharged during such movement and positioning. This is in contrast to when conventional transport machines are used, in which case exhaust gas is discharged. Hence, the cushioned pallet assembly of the present invention is environmentally friendly.

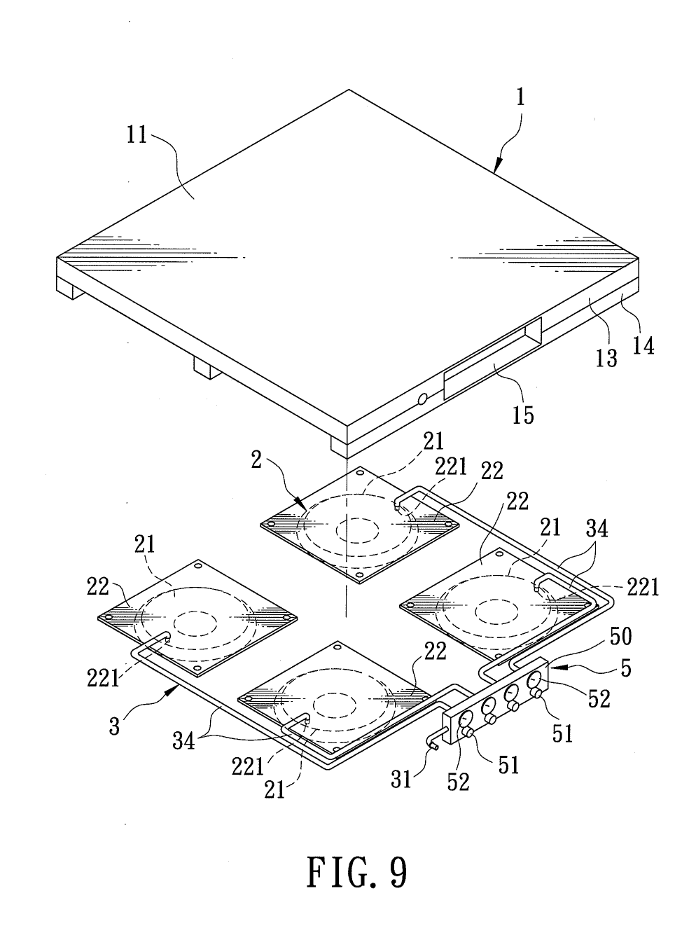

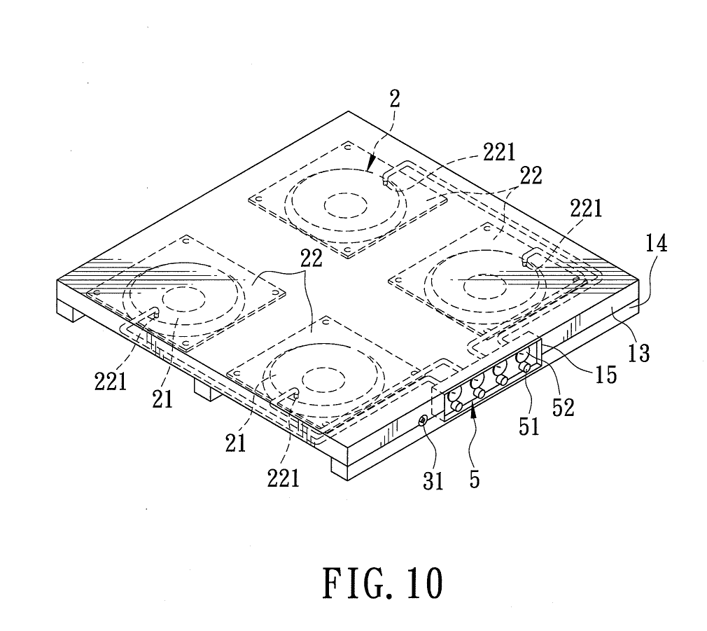

Referring to FIGS. 9 and 10, a cushioned pallet assembly according to the second preferred embodiment of the present invention is shown to be similar to the first preferred embodiment. However, in this embodiment, the cushioned pallet assembly further comprises a pressure control unit 5 which includes a manifold 50 installed in a groove 15 formed in one of the lateral sides 13 of the pallet body 1 and the adjacent standoff bar 14, four pressure regulating valves 51 connected to the manifold 50, and four pressure gauges 52 connected to the manifold 50 adjacent to the respective pressure regulating valves 51. Each pressure regulating valve 51 and the adjacent pressure gauge 52 cooperatively control the inflating pressure of a respective one of the air bags 21. Further, the air supply conduit unit 3 includes one air connector 31 and four conduits 34. The air connector 31 has one end connected to the manifold 50, and the other end adapted to be connected to the air source 4 (see FIG. 2). Each conduit 34 has one end connected to the bag inlet 221 of the respective partition plate 22, and the other end connected to the respective pressure regulating valve 51, the respective pressure gauge 52, and the manifold 50.

To use the cushioned pallet assembly of the second preferred embodiment, when the pallet body 1 with a load placed on the top face 11 thereof is to be transferred to another place, the air connector 31 is first connected to the air source 4 (see FIG. 2) so as to guide pressurized air from the air source 4 to the pressure control unit 5. The amount of pressure of the pressurized air for inflating each air bag 21 is controlled by the respective pressure regulating valve 51, and is indicated by the respective pressure gauge 52. The air bags 21 are inflated until the pressure needed to push the loaded pallet body 1 becomes small. At this time, a thin film of air is formed between each air bag 21 and the ground, and the loaded pallet body 1 is raised from the ground. Only a light force is necessary to push and move the loaded pallet body 1 to a desired angle and direction. Hence, the advantages of the first preferred embodiment can be similarly achieved using the second preferred embodiment.

It should be noted that when the load is placed unevenly on the top face 11 of the pallet body 1 so that the air bags 21 have to bear different loads and thus have to provide different upward supporting forces to thereby permit the pallet body 1 to achieve a good horizontal support, in this embodiment, the step of adjusting each air bag 21 so as to produce a desired upward supporting force is simple. That is, by adjusting the pressure for inflating each air bag 21 through the pressure regulating valve 51 that is connected to the respective air bag 21, the desired upward supporting force may thus be obtained.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. A cushioned pallet assembly comprising:
a rigid pallet body having four lateral sides;
an air bag unit including at least one inflatable air bag mounted to said pallet body and capable of producing a pressurized layer of air beneath said air bag; and
an air supply conduit unit connected to said air bag for supplying air to the same.

2. The cushioned pallet assembly of claim 1, wherein said air supply conduit unit includes at least one air connector provided at one of said lateral sides of said pallet body and having a connector inlet adapted to be connected to an air source.

3. The cushioned pallet assembly of claim 2, wherein said pallet body further has top and bottom faces, said air bag being disposed below said bottom face.

4. The cushioned pallet assembly of claim 3, wherein said pallet body further has a plurality of spaced-apart standoff bars provided beneath said bottom face thereof, said air bag having a height smaller than that of each of said standoff bars when said air bag is in a non-inflated state.

5. The cushioned pallet assembly of claim 1, further comprising a partition plate fixed to said air bag and connected to said pallet body, said partition plate having a bag inlet connected fluidly to said air supply conduit unit and said air bag.

6. The cushioned pallet assembly of claim 5, further comprising a plurality of fasteners to fasten said partition plate to said pallet body.

7. The cushioned pallet assembly of claim 5, wherein said pallet body further has a pair of slide rails provided on said bottom face thereof to receive slidably said partition plate.

8. The cushioned pallet assembly of claim 2, wherein said air connector shuts off after being disconnected from the air source.

9. The cushioned pallet assembly of claim 2, wherein said air connector is a quick connector.

10. The cushioned pallet assembly of claim 4, wherein said cushioned pallet assembly comprises four said air bags arranged in intersecting rows and disposed below said bottom face of said pallet body, said air supply conduit unit including four said air connectors provided respectively on said four lateral sides of said pallet body.

11. The cushioned pallet assembly of claim 10, wherein said air supply conduit unit further includes two intersecting main conduits each extending between said rows of said air bags and each having two opposite ends connected to two of said air connectors, and four sub-conduits each extending from one of said main conduits to one of said air bags and each having a conduit outlet connected to a respective one of said air bags, whereby said connector inlet of each of said air connectors can have an air inlet pressure similar to an air outlet pressure at one of said conduit outlets of said sub-conduits.

12. The cushioned pallet assembly of claim 11, wherein two of said sub-conduits branch oppositely from one of said main conduits between two of said air bags, and the other two of said sub-conduits branch oppositely from said one of said main conduits between the other two of said air bags.

13. The cushioned pallet assembly of claim 11, wherein said main conduits and said sub-conduits extend beneath said bottom face of said pallet body.

14. The cushioned pallet assembly of claim 11, wherein said main conduits and said sub-conduits are disposed within said pallet body.

15. The cushioned pallet assembly of claim 4, further comprising a pressure control unit mounted to said pallet body and connected to said air supply conduit unit.

16. The cushioned pallet assembly of claim 15, wherein said pressure control unit includes a manifold installed in one of said lateral sides of said pallet body, and at least one pressure regulating valve connected to said manifold to control a pressure within said air supply conduit unit.

17. The cushioned pallet assembly of claim 16, wherein said pressure control unit further includes at least one pressure gauge connected to said manifold.
